(19) United States
(12) Patent Application Publication
(10) Pub. No.: US 2021/0046862 A1
(43) Pub. Date: Feb. 18, 2021

(54) METHOD AND APPARATUS FOR CONTROLLING A LIGHTING SYSTEM OF A VEHICLE

(71) Applicant: SZ DJI TECHNOLOGY CO., LTD., Shenzhen (CN)

(72) Inventor: Mingyu WANG, Shenzhen (CN)

(21) Appl. No.: 17/086,107

(22) Filed: Oct. 30, 2020

Related U.S. Application Data
(63) Continuation of application No. PCT/CN2018/113038, filed on Oct. 31, 2018.

(51) Int. Cl. B60Q 1/14; G06T 7/593; B60Q 1/08; G06K 9/00

(52) U.S. Cl. CPC B60Q 1/143; G06T 7/593; B60Q 1/08; G06K 9/00825; B60Q 2300/40; G06T 2207/30252; B60Q 2200/30; B60Q 2300/112; B60Q 2300/314; G06T 2207/10021

(57) ABSTRACT

A method and an apparatus for controlling a lighting system of a vehicle are provided. The method includes: collecting environmental information. The environmental information includes an image of an environment of the vehicle and a distance from an object in the environment to the vehicle. The method also includes automatically adjusting the lighting system of the vehicle based on the environmental information.

### CROSS-REFERENCE TO RELATED APPLICATION

This application is a continuation of International Application No. PCT/CN2018/113038, filed Oct. 31, 2018, the entire content of which is incorporated herein by reference.

### TECHNICAL FIELD

The present disclosure relates to automobile technologies and, more particularly, to a method and apparatus for controlling a lighting system of a vehicle.

### BACKGROUND

Adaptive Front-Lighting System (AFS) can dynamically adjust high beam headlights of a vehicle according to an angle of the steering wheel and a current speed, thereby keeping the direction of the high beam headlights in line with the current driving direction of a car to ensure illumination and visibility of the road ahead. The AFS system can enhance the safety of driving in the dark.

With the development of advanced driver-assistance system and automatic driving system, the car driving process becomes more intelligent. The steering follow-up function of the AFS system can only apply to limited scenarios such as direction turning, which cannot satisfy the requirements of intelligent driving.

The disclosed method and system are directed to solve one or more problems set forth above and other problems.

### SUMMARY

In accordance with the present disclosure, there is provided a method for controlling a lighting system of a vehicle. The method includes: collecting environmental information. The environmental information includes an image of an environment of the vehicle and a distance from an object in the environment to the vehicle. The method also includes automatically adjusting the lighting system of the vehicle based on the environmental information.

Also in accordance with the present disclosure, there is provided an apparatus for controlling a lighting system of a vehicle. The apparatus includes a storage medium and a processor. The processor is configured to collect environmental information. The environmental information includes an image of an environment of the vehicle and a distance from an object in the environment to the vehicle. The processor is also automatically adjusting the lighting system of the vehicle based on the environmental information.

### BRIEF DESCRIPTION OF THE DRAWINGS

FIG. 1 is a schematic block diagram showing a vehicle according to exemplary embodiments of the present disclosure;

FIG. 2 is a schematic block diagram showing a computing device according to exemplary embodiments of the present disclosure;

FIG. 3 is a flow chart of a process for controlling a lighting system of a vehicle according to exemplary embodiments of the present disclosure;

FIG. 4 is a flow chart of a process for controlling a lighting system of a vehicle according to exemplary embodiments of the present disclosure;

FIG. 5 is a flow chart of a process for controlling a lighting system of a vehicle according to exemplary embodiments of the present disclosure;

FIG. 6 is a schematic diagram showing an application scenario according to an exemplary embodiment of the present disclosure;

FIG. 7 a schematic diagram showing another application scenario according to an exemplary embodiment of the present disclosure; and

FIG. 8 is a front view of an object in FIG. 7 according to an exemplary embodiment of the present disclosure.

### DESCRIPTION OF THE EMBODIMENTS

Hereinafter, embodiments consistent with the disclosure will be described with reference to the drawings, which are merely examples for illustrative purposes and are not intended to limit the scope of the disclosure. Wherever possible, the same reference numbers will be used throughout the drawings to refer to the same or like parts.

The present disclosure provides a method and apparatus for controlling a lighting system of a vehicle. A vehicle, as used herein, can refer to any movable object that is equipped with a lighting system, such as a car, a motorcycle, a mobile robot, an unmanned aerial vehicle, a boat, a submarine, a spacecraft, a satellite, etc. The lighting system of the movable object may include one or more lamps that emit light and illuminate an external environment and/or an internal environment of the movable object. A lamp, as used herein, may refer to any suitable light source, such as a light-emitting diode (LED) lamp, a filament lamp, a gas discharge lamp, etc. The disclosed apparatus can, based on information collected by an advanced driver-assistance system, determine a current driving scenario and surrounding environment, and adjust the lighting system accordingly. For example, the disclosed apparatus can recognize various conditions such as making a turn and passing-by another vehicle, and select different light illumination modes/patterns according to the various conditions.

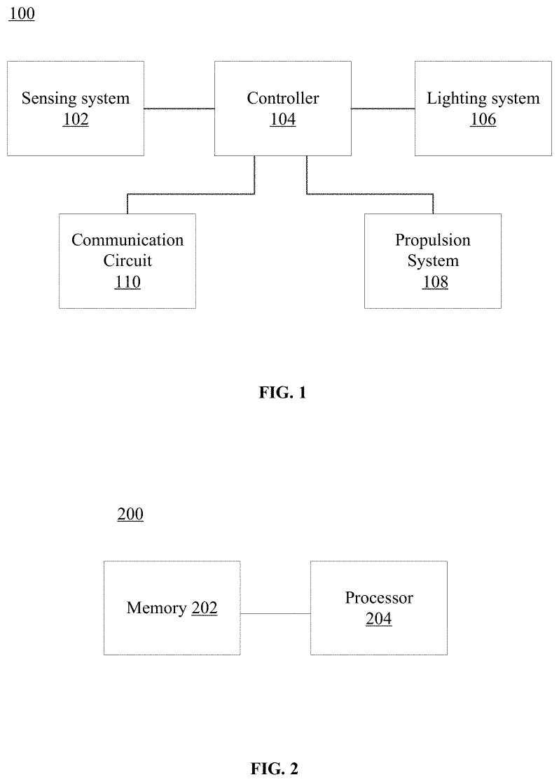

FIG. 1 is a schematic block diagram showing an exemplary vehicle 100 according to exemplary embodiments of the present disclosure. As shown in FIG. 1, the vehicle 100 includes a sensing system 102, a controller 104, a lighting system 106, and a propulsion system 108. In some embodiments, as shown in FIG. 1, the vehicle 100 further includes a communication circuit 110. The apparatus for controlling a lighting system of a vehicle provided by the present disclosure can be applied in the vehicle 100. For example, the sensing system 102 and the controller 104 may implement functions of the disclosed apparatus.

The sensing system 102 can include one or more sensors that may sense and collect initial environmental information of the vehicle. The sensing system 102 may include at least one image sensor and may be configured to obtain an image of an environment of the vehicle using the at least one image sensor. The at least one image sensor can be any imaging device capable of detecting visible, infrared, and/or ultraviolet light, such as a camera. In some embodiments, the at least one image sensor may be located on board the vehicle, such as a front facing camera, a rear facing camera, etc. In some embodiments, the sensing system 102 may be configured to capture a plurality of raw images using the at least one image sensor. A panoramic image may be generated using the raw images by the sensing system 102 and/or the controller 104. In some embodiments, the at least one image sensor includes a stereo vision system configured to capture one or more stereo images. The one or more stereo images may be used to obtain depth information corresponding to an object captured by the stereo vision system based on binocular disparity. The depth information may be used to determine a distance between the object and the vehicle.

The sensing system 102 may also include at least one proximity sensor. The at least one proximity sensor can include any device capable of emitting electro-magnetic waves and detecting/receiving the electro-magnetic waves reflected by an object, such as an ultrasonic sensor, a millimeter wave radar (MWR), a laser radar, a LiDAR sensor, a time-of-flight camera, etc. In some embodiments, the sensing system 102 may be configured to use the LiDAR sensor to measure a distance to a target by illuminating the target with pulsed laser light and measuring the time taken for the reflected pulses to be received. For example, the LiDAR sensor may be configured to scan all directions (360 degrees) around the vehicle at one or more height levels to obtain relative locations of surrounding objects and measure the distances between the vehicle and the surrounding objects. Further, data from the stereo vision system and the proximity sensor can be matched and integrated to determine a relative location of a surrounding object with higher accuracy.

Additional examples of sensors included in the sensing system 102 may include but are not limited to: speedometers, location sensors (e.g., global positioning system (GPS) sensors, mobile device transmitters enabling location triangulation), inertial sensors (e.g., accelerometers, gyroscopes), altitude sensors, pressure sensors (e.g., barometers), audio sensors (e.g., microphones), or field sensors (e.g., magnetometers, electromagnetic sensors). For example, the speedometer, the location sensors and the inertial sensors may be used to evaluate movement status information of the vehicle itself. A three-dimensional reconstruction of the changing environment of the vehicle may be obtained and tracked according to the movement status information of the vehicle and the relative location of surrounding objects.

Any suitable number and/or combination of sensors can be included in the sensing system 102. Sensing data collected and/or analyzed by the sensing system 102 can be used as the environmental information of the vehicle. The environmental information can be used to automatically adjust the lighting system 106 (e.g., through a suitable processing unit such as the controller 104). In some embodiments, the environmental information can also be used to control the spatial disposition, velocity, and/or orientation of the vehicle.

The controller 104 may be configured to control operation of one or more components of the vehicle (e.g., based on analysis of sensing data from the sensing system 102), such as the lighting system 106, the propulsion system 108, and/or the communication circuit 110. The controller 104 may include any suitable hardware processor. The controller 104 may be configured to process the initial environmental information from the sensing system 102, such as performing object recognition on an image to identify the object in the environment of the vehicle, determining the distance between the object and the vehicle based on at least one of electro-magnetic waves detected by a radar or the image, etc. In some embodiments, the controller 104 may implement an artificial intelligent processor to analyze the environmental information. For example, a convoluted neural network (CNN) algorithm may be implemented to perform the object recognition on captured images. In some embodiments, when an object is recognized in an image, the controller 104 may be further configured to match the object identified in the image with an object detected by a proximity sensor (e.g., a LiDAR) as the same object, and determine the distance between the object and the vehicle based on a distance to the object detected by the proximity sensor. In some embodiments, the distance between the object and the vehicle may also be determined based on stereo images captured by a stereo vision system of the sensing system 102. In some embodiments, the vehicle may include a steering decision element. The steering decision element may generate a movement command based on a manual input from a driver of the vehicle, a steering decision of a driver-assistance system of the vehicle, and/or a steering decision of an automatic driving system of the vehicle. The movement command may include, for example, turning towards a specified direction, and/or moving based on a specified route. The controller 104 may be configured to determine a lighting adjustment configuration of the object associated with the movement command; and adjust a light directed towards a region associated with the object according to the lighting adjustment configuration.

The lighting system 106 may be configured to receive a command from the controller 104 and emit light based on the command. An illumination pattern of a lamp in the lighting system 106 may be adjusted based on the command, such as turning on/off the lamp, increasing/decreasing an intensity/brightness to a certain level, adjusting a color and/or color temperature, etc. In some embodiments, adjusting the illumination pattern of the lamp may include adjusting an illuminate direction of the lamp. In one example, the lamp is disposed on a movable housing structure of the vehicle 100, and the illuminate direction of the lamp can be adjusted by controlling a movement of the housing structure. In another example, the lamp is coupled to a movable reflector structure configured to direct the light emitted by the lamp to follow a suitable optical path. The illuminate direction of the lamp can be adjusted by controlling a movement of the reflector structure (e.g., tilting the reflector structure for a certain angle). In some embodiments, the illumination pattern of a lamp may include adjusting intensities according to a predetermined time sequence, such as alternately turning the lamp on and off at a set time interval and repeating for certain times.

In some embodiments, the lighting system 106 may include one or more headlights, tail lights, daytime running lights, fog lights, signal lights, brake lights, hazard lights, puddle lights, interior lights, etc. In some embodiments, the lighting system 106 may include two head lamp groups (e.g., driver-side lamp group and passenger-side lamp group), and each lamp group may include one or more high beam lamps and one or more low beam lamps. A lamp of the lighting system 106 that can be controlled individually and/or in groups based on the command from the controller 104.

The propulsion system 108 may be configured to enable the vehicle 100 to perform a desired movement (e.g., in response to a control signal from the controller 104, in response to a movement command from the steering decision element), such as speeding up, slowing down, making a turn, moving along a certain path, moving at a certain speed toward a certain direction, etc. The propulsion system 108 may include one or more of any suitable propellers, blades, rotors, motors, engines and the like to enable movement of the vehicle. Further, the controller 104 may be configured to adjust the lighting system 106 in accordance with the movement generated by the propulsion system 108.

The communication circuit 110 may be configured to establish communication and perform data transmission with another device (e.g., an object in an environment of the vehicle), such as a communication circuit of another vehicle. The communication circuit 110 may include any number of transmitters and/or receivers suitable for wired and/or wireless communication. The communication circuit 110 may include one or more antennas for wireless communication at any supported frequency channel. The communication circuit 110 may be configured to transmit incoming data received from the object to the controller 104, and send outgoing data from the controller 140 to the object. The communication circuit 110 may support any suitable communication protocol for communicating with the object, such as a Vehicle to Vehicle communication protocol, a software-defined radio (SDR) communication protocol, a Wi-Fi communication protocol, a Bluetooth communication protocol, a Zigbee communication protocol, a WiMAX communication protocol, an LTE communication protocol, a GPRS communication protocol, a CDMA communication protocol, a GSM communication protocol, or a coded orthogonal frequency-division multiplexing (COFDM) communication protocol, etc.

In some embodiments, wireless communication information from the object may be included in the environmental information and used to adjust the lighting system 106. In one example, the wireless communication information may include operation information of the object. The distance between the object and the vehicle may be determined based on a location of the object extracted from the wireless communication information (e.g., the operation information) and a current location of the vehicle. In another example, the wireless communication information may include a lighting adjustment request from the object. The controller 104 may be configured to accept the lighting adjustment request and control the lighting system 106 to adjust a light directed toward a region associated with the object based on the lighting adjustment request, or deny the lighting adjustment request and control the lighting system 106 to adjust based on analysis of the environmental information.

In some embodiments, the communication circuit 110 of the vehicle 100 may be configured to send a light controlling command to the object. The light controlling command may be configured to adjust a light emitted by a lamp of the object, such as turning off a high-beam lamp of the object whose light is directed to the vehicle 100, or adjusting a lighting direction of a lamp of the object to avoid glare to the driver of the vehicle 100. For example, based on the communication protocol, the communication circuit 110 of the vehicle 100 may have priority in controlling a lamp of the object that emits a light passing through an area of the vehicle 100. In other words, the object may respond to the light controlling command from the vehicle 100 with first priority, e.g., to avoid glare to the vehicle 100. In one example, before sending the light controlling command, the vehicle 100 (e.g., the controller 104) may receive wireless communication information from the object that indicates specifications of the lighting system of the object, and determine the lamp on the object to be adjusted. In another example, the communication circuit 110 may send out, together with or incorporated within the light controlling command, information about the vehicle 100 such as the location, speed and/or moving direction of the vehicle to the object, and the object may determine, in response to the light controlling command, which lamp to be adjusted and details of such adjustment (e.g., turning on/off, brightness adjustment, lighting direction adjustment) based on information of the object and the information about the vehicle.

FIG. 2 is a schematic block diagram showing a computing device 200 according to exemplary embodiments of the present disclosure. The computing device 200 may be implemented in the disclosed apparatus for controlling a lighting system and/or the vehicle 100, and can be configured to control a lighting system of the vehicle consistent with the disclosure. As shown in FIG. 2, the computing device 200 includes at least one storage medium 202, and at least one processor 204. According to the disclosure, the at least one storage medium 202 and the at least one processor 204 can be separate devices, or any two or more of them can be integrated in one device.

The at least one storage medium 202 can include a non-transitory computer-readable storage medium, such as a random-access memory (RAM), a read only memory, a flash memory, a volatile memory, a hard disk storage, or an optical medium. The at least one storage medium 202 coupled to the at least one processor 204 may be configured to store instructions and/or data. For example, the at least one storage medium 202 may be configured to store data collected by the sensing system 102 (e.g., image captured by the image sensor), trained classification model for object recognition, light adjustment configurations corresponding to different types of objects and/or operation scenarios, computer executable instructions for implementing a process of adjusting a lighting system, and/or the like.

The at least one processor 204 can include any suitable hardware processor, such as a microprocessor, a micro-controller, a central processing unit (CPU), a network processor (NP), a digital signal processor (DSP), an application specific integrated circuit (ASIC), a field-programmable gate array (FPGA), or another programmable logic device, discrete gate or transistor logic device, discrete hardware component. The at least one storage medium 202 stores computer program codes that, when executed by the at least one processor 204, control the at least one processor 204 to perform a method for controlling a lighting system consistent with the disclosure, such as one of the exemplary methods described below. In some embodiments, the computer program codes also control the at least one processor 204 to perform some or all of the functions that can be performed by the vehicle 100 and/or the disclosed apparatus as described above, each of which can be an example of the computing device 200.

In some embodiments, the computing device 200 may include other I/O (input/output) devices, such as a display, a control panel, a speaker, etc. In operation, the computing device 200 may implement a method of controlling a lighting system of a vehicle as disclosed herein.

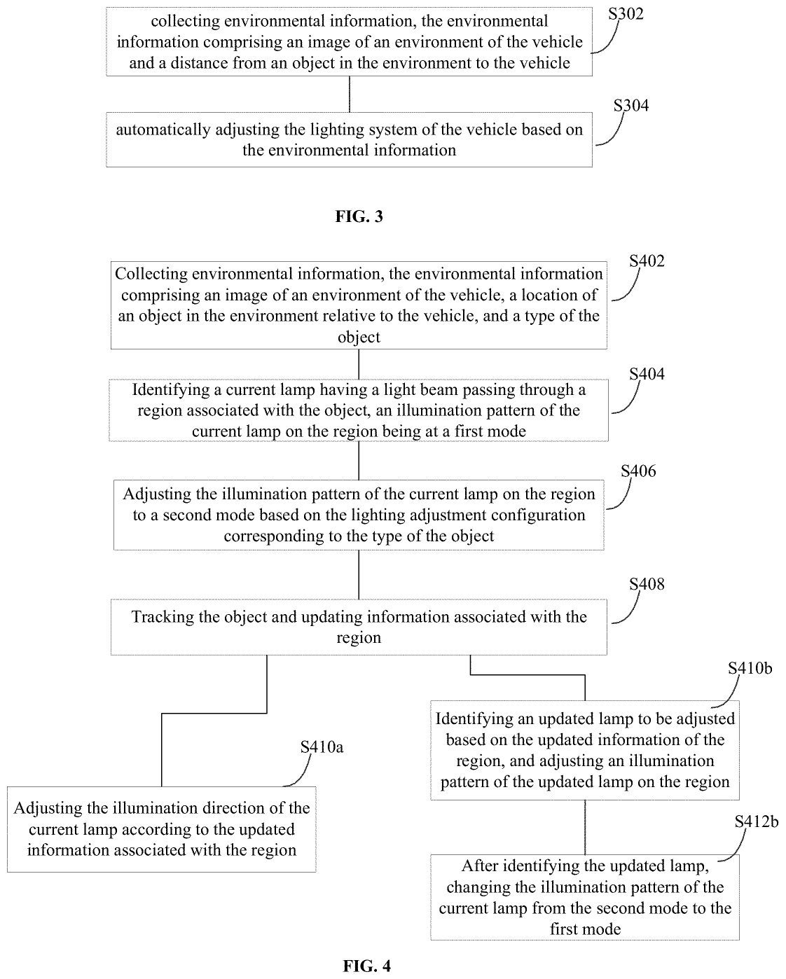

FIG. 3 is a flow chart of a process for controlling a lighting system of a vehicle according to exemplary embodiments of the present disclosure. The disclosed process can be implemented by a computing system, such as the vehicle 100 and/or the device 200. The disclosed process can be applied to a vehicle having a lighting system (e.g., the lighting system 106).

As shown in FIG. 3, the disclosed method includes collecting environmental information (S302). The environmental information may include an image of an environment of the vehicle. The image of the environment of the vehicle may be an image captured by an image sensor or an image generated based on one or more captured raw images. The image may also be an image frame extracted from a captured video. The image may depict the environment of the vehicle and include projection of one or more objects in the environment of the vehicle. The environmental information may further include a distance from an object in the environment to the vehicle. The object may be one of the one or more objects appeared in the image. The distance between the object and the vehicle may be determined using image data from the at least one sensor (e.g., the image) and/or sensing data from a proximity sensor. When image data from the at least one image sensor is used to determine the distance, a relative location between the object and the vehicle may also be obtained according to a facing direction of the image sensor and position of the object in the image. When sensing data from the proximity sensor is collected, the relative location between the object and the vehicle may be directly obtained based on the sensing data.

In some embodiments, collecting environmental information may further include collecting initial environmental information and processing the initial environmental information to obtain the environment information. The initial environmental information may be collected by the sensing system 102. At least one image sensor may be used to capture the image of the environment of the vehicle. The image sensor may be placed at any suitable location on the vehicle and face any suitable direction from the vehicle to obtain views related to the vehicle, such as front view, rear view, side view, surround view, etc. In some embodiments, raw images taken by multiple image sensors or by one image sensor rotated at different angles may be used to generate a combined image that covers a wider angle of view than each individual raw image. In one example, a panoramic image may be produced based on the raw images. In another example, multiple image sensors may be mounted at the front, sides and rear of the vehicle to create a 360 degree “bird's eye” full-visibility view around the vehicle. When combining the raw images, the computing system (e.g., controller 104) may adjust brightness of the raw images and geometrically align the raw images to generate the combined image. In some embodiments, settings of the multiple image sensors may be dynamically adjusted based on surrounding lighting conditions. In some embodiments, an image sensor having a wide-angle lens or an ultra-wide “fisheye” lens may be used to capture a raw image. Image processing techniques, such as barrel lens distortion correction and image plane projection, may be employed to compensate the wide-angle lens effect and produce an image with straight lines and natural view for further analysis. In some embodiments, image processing techniques may be employed to enhance or filter certain features in an image for further analysis, such as noise filtering, contrast adjustment, mask filtering, histogram equalization, etc.

Object recognition may be performed on an image (e.g., an image captured by an image sensor, an image produced based on one or more captured images) to identify one or more objects in the environment of the vehicle. A result of the object recognition may be included in the environmental information and used to determine adjustment of the lighting system. The result of object recognition may include, for each recognized object, a bounding area corresponding to the object and a type of the object. In some embodiments, multiple instances of a same type of object may be detected in the image. Any suitable types/classes of objects may be detectable by the computing system, such as traffic sign, road lane mark, pedestrian, animal, car, truck, motorcycle, bicycle, tree, building, etc. In some embodiments, object recognition is performed on a selected image, such as a front-view image, an image having a quality higher than a certain threshold, etc. In some embodiments, object recognition is continuously performed on a series of images chronologically obtained as the vehicle is moving. Further, a target object may be tracked based on the series of images. Additionally, the computing system may determine whether a tracked object is moving and movement information of the tracked object (e.g., moving direction, moving speed) based on the series of images.

Any suitable computer vision technique may be employed for identifying objects in a given image, such as deep learning or machine learning algorithms. Training data can be loaded to the computing system. In one example, the training data may include a model trained using a deep learning technique such as convolutional neural network (CNN). CNN can be implemented to automatically analyze a plurality of training images of objects belonging to known classes and learn features that distinguish one class from other classes. When performing object recognition, the learned features are extracted from the given image, classification of an object can be obtained based on the trained model and the extracted features of the given image. In another example, the training data may include the training images of objects belonging to known classes, and designated feature extraction algorithms for extracting selected features in the training images and the given image. The designated feature extraction algorithms may include, for example, oriented gradients (HOG) feature detector, Speeded Up Robust Features (SURF) detector, Maximally Stable Extremal Regions (MSER) feature detector, Haar feature extraction, etc. A machine learning algorithm, such as Support Vector Machine (SVM) model, Bag of words model, may be implemented to classify the given image based on the extracted features of the training images and the extracted features of the given image.

In some embodiments, the deep learning or machine learning algorithm may be directly implemented on the image to identify multiple objects. In some other embodiments, the computing system may preprocess the image by determining one or more areas of the image as one or more bounding areas of objects, and implement the object recognition technique on each determined area of the image to identify a type of an object in the determined area. The one or more areas of the image may be determined based on any suitable image processing algorithm, such as blob detection, clustering algorithm, etc.

In some embodiments, collecting the environmental information may further include using a stereo vision system to obtain stereo images of the environment of the vehicle. A depth map (e.g., binocular disparity map) may be generated based on the stereo images. Further, performing object recognition may include identifying an object in the depth map and obtain a distance between the object and the vehicle based on the depth information corresponding to the object. In some embodiments, a stereo image may be directly used for object recognition. In some other embodiments, object recognition may be performed on another two-dimensional (2D) image captured at substantially the same time as the stereo image. The 2D image may be matched with the stereo image to determine an area in the stereo image that correspond to the same object recognized on the 2D image. The depth information of the object can be obtained when a successful matching is completed.

Collecting the environmental information may also include: emitting, by at least one proximity sensor, electro-magnetic waves and receiving the electro-magnetic waves reflected by one or more objects in the environment of the vehicle. The distances between the one or more objects and the vehicle can be determined based on the reflected electro-magnetic waves.

In some embodiments, information from the image sensor and the proximity sensor may be integrated. For example, an object identified in the image may be matched with an object detected by the proximity sensor as the same object, and the distance between the object and the vehicle can be determined as the distance detected by the proximity sensor. In some embodiments, the stereo vision system may be configured to facilitate matching the object identified from image data collected by the at least one image sensor with an object detected by the proximity sensor. For example, depth information of a first object can be determined using a stereo image captured by the stereo vision system; distance measurement corresponding to a second object detected by the proximity sensor can be obtained, and when a difference between the depth information and the distance measurement is less than a threshold value, it is considered that the first object and the second object are the same object.

The lighting system of the vehicle can be automatically adjusted based on the environmental information (S304). For example, lighting adjustment configurations prestored in the computing system may be searched and a lighting adjustment configuration corresponding to a scenario/occasion depicted by the environmental information may be selected and implemented. The lighting adjustment configuration may include increasing or decreasing a lighting intensity on a region associated with an object, i.e., the intensity of light emitted toward the region associated with the object. A region associated with an object may refer to a region that contains the object, a region that is a portion of the object, and/or a region at which the object will be located in a future moment (e.g., next second) predicted based on an object tracking result.

In some embodiments, when the lighting adjustment configuration includes increasing a light intensity on a region associated with the object, automatically adjusting the lighting system may include: identifying a first lamp having a light beam passing through the region, and turning on the first lamp or increasing a light intensity of the first lamp. A lamp having a light beam passing through a region is identified based on the environmental information. For example, each lamp of the lighting system may have a corresponding aimed space (e.g., a space section having a cone shape with an apex at the lamp) where the light beam of the lamp passes through based on the placement of the lamp (e.g., left or right side of the vehicle, a second light among a row of five lamps). A location of the region associated with the object is obtained based on the environmental information. In one embodiment, the computing system may identify, among a plurality of lamps based on their corresponding aimed space, a lamp whose corresponding aimed space that overlaps the most with the region associated with the object. In another embodiment, the computing system may identify one or more lamps whose corresponding aimed spaces having a coverage percentage of the region above a first preset threshold (e.g., 50%). The coverage percentage may be determined by dividing a volume of a part of the region where the light beam passes through (i.e., overlapped with the aimed space) by a total volume of the region, or be determined by dividing an area of a cross-section of the part of the region where the light beam pass through by a total area of a cross-section of the region. The cross-section of the part of the region or the cross-section of the region can be perpendicular to a center line of the light beam. The identified lamp(s) is considered as the first lamp and may be adjusted based on the lighting adjustment configuration.

In some embodiments, when the lighting adjustment configuration includes increasing a light intensity on a region associated with the object, automatically adjusting the lighting system may include: identifying a second lamp having a light beam not passing through the region, and adjusting an illuminate direction of the second lamp to illuminate the region. An adjusting degree of the illumination direction of the second lamp may be determined based on an original aimed space or aimed direction corresponding to the second lamp and a location of the region. Depending on the housing structure of the vehicle 100, the second lamp or a reflector of the second lamp may be rotated and/or spatially moved. In one embodiment, the second lamp may be identified and adjusted when the computing system fails to identify a first lamp having a light beam passing through the region, or when the computing system determines that no lamp whose corresponding aimed space has a coverage percentage of the region above the first preset threshold. A lamp whose aimed space is nearest to the region, or has a highest coverage percentage of the region may be identified as the second lamp. In this way, minimal angle adjustment is needed to illuminate the region. In some embodiments, more than one lamps may be identified as the second lamp, and a combination of the corresponding aimed spaces of the more than one lamps can cover the whole region or most part of the region associated with the object. In another embodiment, the second lamp may be identified when the computing system determines that the coverage percentage corresponding to the identified first lamp is below a second preset threshold (e.g., 90%). The computing system may adjust the illuminate direction of a second lamp to illuminate a part of the region not covered by the first lamp.

In some embodiments, when the lighting adjustment configuration includes decreasing a light intensity on a region associated with the object, adjusting the lighting system includes: identifying a first lamp having a light beam passing through the region. In one embodiment, the computing system may turn off the first lamp, decrease a light intensity of the first lamp, and/or adjust an illuminate direction of the first lamp to avoid the region.

In some embodiments, when the lighting adjustment configuration includes decreasing a light intensity on a region associated with the object, adjusting the lighting system includes: identifying a second lamp having a light beam passing through the region and having a lower intensity than the first lamp, turning on the second lamp, and turning off the first lamp. For example, the first lamp may be a high beam lamp and the second lamp may be a low beam lamp. Both lamps may have light beams passing through the region associated with the object, e.g., the first lamp is located under/above the second lamp vertically.

In some embodiments, the lighting adjustment configuration may include flashing one or more lamps of the lighting system at a predetermined pattern. For example, a group of three lamps may be simultaneously or consecutively turned on and off repeatedly for a predetermined number of times (e.g., 3 times) or at a fixed time interval (e.g., every second) until being instructed otherwise. In some embodiments, the lighting adjustment configuration may include adjusting intensities of one or more lamps of the lighting system according to a time sequence. For example, the time sequence may include two consecutive periods. During the first period, a first lamp may emit light at first intensity, and a second lamp may emit light at second intensity. During the second period, the first lamp may emit light at the second intensity, and the second lamp may emit light at the first intensity.

In some embodiments, the lighting adjustment configuration may include adjusting lighting on a first region of the object with a first lighting adjustment plan, and adjusting lighting on a second region of the object with a second lighting adjustment plan different from the first lighting adjustment plan. For example, lighting intensity on the first region of the object may be increased, and lighting intensity on the second region of the object may be decreased. In some embodiments, the lighting adjustment configuration may include adjusting lighting on a portion of the object. Lighting intensity on the remaining portion of the object may be unchanged. For example, when the object is a vehicle, lighting intensity on the window portion of the vehicle may be decreased and lighting intensity on the remaining portion of the vehicle may be unchanged. When the object is a pedestrian or an animal, lighting intensity on the eye area or face region of the object may be decreased and lighting intensity on the remaining portion, such as the body portion, may be unchanged.

In some embodiments, the lighting adjustment configuration may be selected based on the type of the object obtained from object recognition. FIG. 4 is a flow chart of a process of adjusting a lighting system of a vehicle according to exemplary embodiments of the present disclosure. As shown in FIG. 4, the process includes collecting environmental information (S402). The environmental information includes an image of an environment of the vehicle, a location of an object in the environment relative to the vehicle, and a type of the object.

Types of objects corresponding to light intensity increasing adjustment may include, for example, a traffic light, a traffic sign, a road lane mark, etc. Increasing the light intensity may facilitate the computing system to obtain an image of the object with higher quality and analyze/recognize details of the object with higher accuracy. Types of objects corresponding to light intensity decreasing adjustment may include, for example, a car, a truck, a pedestrian, a building, etc. Decreasing lighting intensity may avoid glare to other vehicle drivers, avoid startling a pedestrian, and/or filtering out information having low relevance (e.g., background objects, stable objects).

A current lamp having a light beam passing through a region associated with the object may be identified (S404). The illumination pattern of the current lamp on the region may be at a first mode. The illumination pattern may include an intensity of the current lamp (e.g., on/off status, brightness level) and/or an illuminate direction of the current lamp. After identifying the current lamp, the illumination pattern of the current lamp on the region may be adjusted to a second mode based on the lighting adjustment configuration corresponding to the type of the object (S406).

The vehicle and the object may be moving relative to each other. The computing system may track the object and updating information associated with the region (S408). For example, as the vehicle approaches or moves away from the object, light beams aiming at different directions may pass through the region associated with the object at different moments, and lighting intensity of the corresponding lamp(s) may be adjusted based on an updated location of the object.

In some embodiments, the illumination direction of the current lamp may be adjusted according to the updated information associated with the region (S410a). The computing system may adjust the illumination direction of the current lamp so that the light beam of the current lamp continues to pass through the region associated with the object. For example, when tracking the object, a moving speed of the object relative to the vehicle and the updated location of the object relative to the vehicle can be obtained. The illumination pattern of the current lamp may be adjusted by rotating the current lamp or a reflector corresponding to the current lamp at an angular speed based on the relative moving speed and the updated location of the object.

In some embodiments, an updated lamp to be adjusted may be identified based on the updated information of the region, and an illumination pattern of the updated lamp on the region may be adjusted (S410b). For example, the computing system may identify a lamp having a light beam passing through the updated location of the region as the updated lamp. The computing system may also predict the region associated with the object at a future moment based on the relative speed, and preemptively identify the lamp to be adjusted at the future moment. In one embodiment, a lamp located at an immediate neighboring position of the current lamp may be identified as the updated lamp based on the relative moving direction of the object. For example, if the vehicle is moving towards the object at a left side, a lamp immediately left to the current lamp may be identified as the updated lamp. The moment of switching the current lamp to the updated lamp may be determined based on the updated location of the object and/or the relative moving speed of the object.

In some embodiments, after identifying the updated lamp, the computing system may change the illumination pattern of the current lamp from the second mode back to the first mode (S412b).

In some embodiments, only one of S410a and S410b may be executed. In some other embodiments, both of S410a and S410b may be executed. For example, if the vehicle is moving towards the object at a left side of the vehicle, and the current lamp is not located at the most left side in its lamp group, S410b may be executed first and the to-be-adjusted lamp is updated as a lamp left to the current lamp. As the vehicle is moving closer towards the object, a lamp located at the most left side becomes the current lamp, and S410a may be executed.

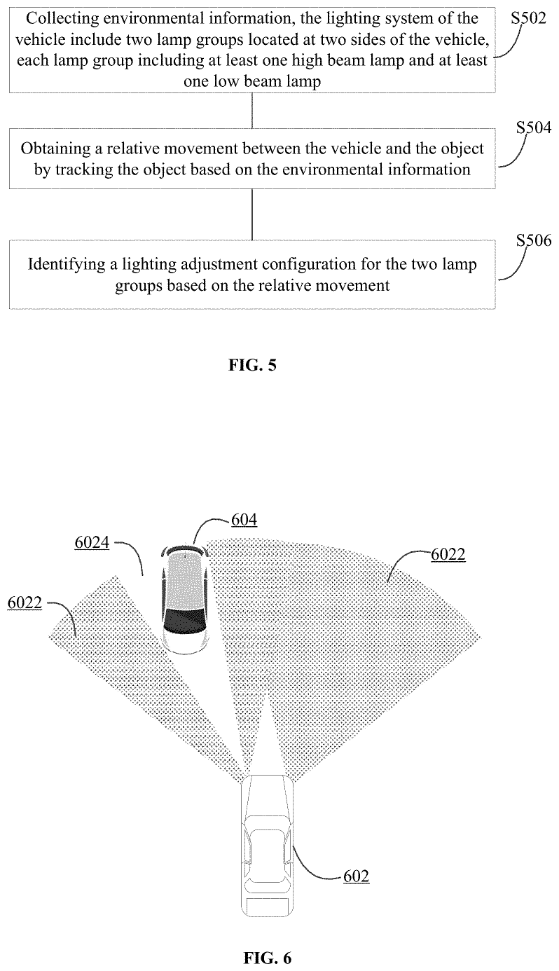

In some embodiments, the lighting system may include two lamp groups located at two sides of the vehicle, each lamp group including at least one high beam lamp and at least one low beam lamp. For example, the two lamp groups may be left headlights and right headlights of a vehicle. The lighting adjustment configuration of the lighting system may be selected based on a relative movement between the vehicle and the object. FIG. 5 is a flow chart of a process of adjusting a lighting system of a vehicle according to exemplary embodiments of the present disclosure. As shown in FIG. 5, the process includes collecting environmental information (S502). The process may also include obtaining a relative movement between the vehicle and the object by tracking the object based on the environmental information (S504). The relative movement may be, for example, the vehicle and the object moving in approximately opposite directions, the vehicle trailing the object, or the vehicle passing by the object. The object may be another vehicle.

A lighting adjustment configuration may be identified for the two lamp groups based on the relative movement (S506). When the relative movement is the vehicle and the object moving in approximately opposite directions, the lighting adjustment configuration includes switching an on/off state between the high beam lamp and the low beam lamp in one of the two lamp groups. For example, the high beam lamp and the low beam lamp in a same lamp group may have opposite on/off status. If the object is at the left side of the vehicle, the high beam lamp in the left-side lamp group may be changed from an on status to an off status, and the low beam lamp in the left-side lamp group may be changed from an off status to an on status. Illumination pattern of lamps in the right-side lamp group may be unchanged.

When the relative movement is the vehicle trailing the object, the lighting adjustment configuration includes turning off the high beam lamp in each of the two lamp groups. In some embodiments, the low beam lamp in both lamp groups may be turned on.

When the relative movement is the vehicle passing by the object (e.g., the vehicle and the object are moving towards approximately same direction), the lighting adjustment configuration includes alternately turning on the high beam lamp in each of the two lamp groups and turning on the low beam lamp in each of the two lamp groups (e.g., repeatedly for three times).

In some embodiments, each of the two lamp groups comprises multiple high beam lamps. When the lighting adjustment configuration includes turning on a high beam lamp of one lamp group, the computing system may identify one or more of the high beam lamps of the one lamp group that do not have a light beam passing through a region of the object, and turn on the identified one or more high beam lamps. The remaining high beam lamp(s) of the one lamp group may continue to be at an off status. For example, the relative movement is the vehicle passing by the object from a left side of the object, and a first high beam lamp of the right-side lamp group is determined as having a light beam passing through a region of the object. When it is time to turn on the high beam lamp based on the lighting adjustment configuration, the first high beam lamp remains off, and other high beam lamp(s) of the right-side lamp group are turned on.

The process described above in connection with FIG. 5 may be applied in night operation scenarios to avoid glare caused by the high beam lamp. The object may be a moving object, such as a vehicle or a pedestrian. In some embodiments, when executing the process described in connection with FIG. 5, the object may be determined as a general moving object, and the exact type of the object may not necessarily be identified.

In some embodiments, the two processes described above in connection with FIG. 4 and FIG. 5, respectively, may be combined to control the lighting system of the vehicle based on the distance between the object and the vehicle. For example, the computing system may determine whether the distance between the object and the vehicle is less than a threshold distance. When the distance is not less than the threshold distance, the process described above in connection with FIG. 5 can be implemented. When the distance is less than the threshold distance, the process described above in connection with FIG. 4 can be implemented. That is, when the object is far away from the vehicle, only general and coarse movement information is required/collected to determine a corresponding lighting adjustment configuration; and when the object is close to the vehicle, more valuable information can be obtained (e.g., image of the object with higher visibility) and object recognition/detection can be performed with high confidence level.

FIG. 6 is a schematic diagram showing an application scenario according to an exemplary embodiment of the present disclosure. As shown in FIG. 6, a vehicle 602 (e.g., the vehicle 100 equipped with the disclosed apparatus and/or the computing device 200) and an object 604 (a passing vehicle) are facing opposite directions. When the distance between the object 604 and the vehicle 602 is not less than the threshold distance, the lighting system of the vehicle 602 can be adjusted based on the relative movement between the two vehicles. For example, the relative movement is the vehicle 602 and the object 604 moving in approximately opposite directions and the object 604 is on the left side of the vehicle 602. In this scenario, the lighting adjustment configuration can include turning off the high beam lamp in the left-side lamp group. Area 6024 corresponds to one or more high beam lamps in the left-side lamp group having a light beam passing through the object 604. Area 6022 corresponds to one or more lamps in the lighting system whose light beam does not pass through the object 604 and illumination pattern is not altered.

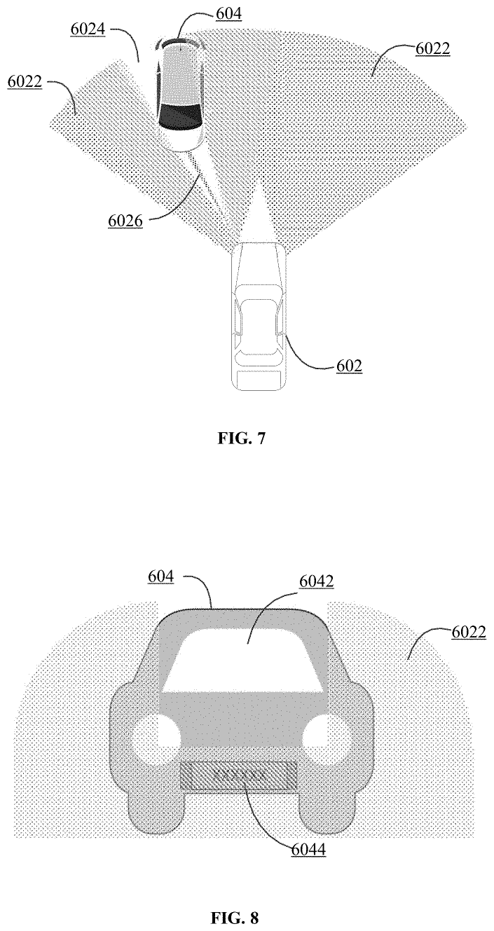

FIG. 7 is a schematic diagram showing an application scenario according to another exemplary embodiment of the present disclosure. FIG. 8 is a front view of the object 604 in FIG. 7. When the distance between the object 604 and the vehicle 602 is not less than the threshold distance, the lighting system of the vehicle 602 can be adjusted based on the type of the object. For example, the type of the object is vehicle type, the lighting adjustment configuration corresponding to the type may include decreasing an intensity on a window region of the object to a first level, and increasing an intensity on a license plate region of the object to a second level. As shown in FIG. 7 and FIG. 8, Area 6024 corresponds to one or more lamps having a light beam passing through the window region 6042, and the intensity of the light beam is at the first level. Area 6026 corresponds to one or more lamps having a light beam passing through the license plate region 6044, and the intensity of the light beam is at the second level. Area 6022 corresponds to one or more lamps in the lighting system whose light beam does not pass through the window region 6042 or the license plate region 6044.

Referring again to FIG. 3, in some embodiments, the lighting adjustment configuration may include adjusting an intensity of an interior light based on ambient light intensity. For example, the dashboard light may be set to a lower intensity when the vehicle is in a dark environment compared to a bright environment.

In some embodiments, an image sensor and/or a proximity sensor may be placed at any suitable location to detect an interior environment of the vehicle. For example, head tracking, facial expression tracking, and/or gesture tracking of a driver and or a passenger may be performed using the stereo vision system, the image sensor, and/or the proximity sensor. The lighting adjustment configuration may be determined based on the interior environment. For example, when the environmental information suggests a passenger has closed eyes, the computing system may automatically turn off the roof light at the passenger side. When the environmental information suggests the vehicle is moving in a dark environment and the roof light is on, the computing system may automatically turn off or dim the roof light for safety.

In some embodiments, collecting the environmental information may include receiving a movement command from a steering decision element of the vehicle. The movement command may include, for example, turning towards a specified direction, and moving based on a specified route. The movement command may be generated based on a manual input from a driver of the vehicle, a steering decision of a driver-assistance system of the vehicle, and/or a steering decision of an automatic driving system of the vehicle. Automatically adjusting the lighting system may include determining a lighting adjustment configuration of the object associated with the movement command, and adjusting a light directed towards a region associated with the object according to the lighting adjustment configuration. For example, the movement command may be passing by a target vehicle and the route may include switching to a neighboring lane, increasing moving speed to pass by the target vehicle, and switching back to the original lane. The lighting adjustment configuration may include, turning on signal lights before lane switching, alternating high beam lamp and low beam lamp repeatedly as warning signal during the passing-by period, and turning off signal lights after lane switching.

In some embodiments, collecting the environmental information may also include receiving wireless communication information from the object based on a wireless communication protocol. The object may be, for example, another nearby vehicle that supports the wireless communication protocol, a control center remotely monitoring movement of the vehicle, etc. The wireless communication information may include operation information of the object (e.g., location and moving intent of the nearby vehicle) and/or a lighting adjustment request from the object.

In some embodiments, a location of the object may be extracted from the wireless communication information; and a relative location of the object may be determined based on a current location of the vehicle from the sensing system 102 and the location of the object from the communication information.

In some embodiments, the lighting adjustment request from the object may be accepted and a light directed toward a region associated with the object based on the lighting adjustment request, i.e., an illumination pattern of a corresponding lamp, may be adjusted. Alternatively, the lighting adjustment request may be denied, for example, when the request conflicts with a lighting adjustment configuration corresponding to a type of the object and other information of the object, such as distance and relative location/movement of the object. The lighting system may be adjusted based on the lighting adjustment configuration instead of the lighting adjustment request.

The present disclosure provides a method for controlling a lighting system of a vehicle based on collected environmental information. The disclosed method can be applied to a variety of scenarios and flexibly adjust the lighting system to meet the need of intelligent driving assistance.

The processes shown in the figures associated with the method embodiments can be executed or performed in any suitable order or sequence, which is not limited to the order and sequence shown in the figures and described above. For example, two consecutive processes may be executed substantially simultaneously where appropriate or in parallel to reduce latency and processing time, or be executed in an order reversed to that shown in the figures, depending on the functionality involved.

Further, the components in the figures associated with the device embodiments can be coupled in a manner different from that shown in the figures as needed. Some components may be omitted and additional components may be added.

Other embodiments of the disclosure will be apparent to those skilled in the art from consideration of the specification and practice of the embodiments disclosed herein. It is intended that the specification and examples be considered as exemplary only and not to limit the scope of the disclosure, with a true scope and spirit of the invention being indicated by the following claims.

What is claimed is:

1. A method for controlling a lighting system of a vehicle, comprising:
collecting environmental information, the environmental information comprising an image of an environment of the vehicle and a distance from an object in the environment to the vehicle; and
automatically adjusting the lighting system of the vehicle based on the environmental information.

2. The method of claim 1, wherein collecting the environmental information comprises:
collecting initial environmental information, comprising:
capturing, by at least one image sensor, the image; and
receiving, by at least one proximity sensor, electro-magnetic waves emitted by the at least one proximity sensor and reflected by the object; and
processing the initial environmental information to obtain the environment information, comprising:
performing object recognition on the image to identify the object in the environment of the vehicle; and
determining the distance between the object and the vehicle based on at least one of the electro-magnetic waves or image data collected by the at least one image sensor.

3. The method of claim 2, wherein:
the at least one image sensor includes a stereo vision system; and
capturing the image comprises capturing a stereo image using the stereo vision system.

4. The method of claim 3, wherein determining the distance between the object and the vehicle comprises:
determining depth information corresponding to the object using the stereo image captured by the stereo vision system; and
determining the distance between the object and the vehicle based on the depth information.

5. The method of claim 2, wherein determining the distance between the object and the vehicle comprises:
matching the object identified in the image with an object detected by the at least one proximity sensor as the same object; and
determining the distance between the object and the vehicle based on a distance to the object detected by the at least one proximity sensor.

6. The method of claim 5, wherein:
the at least one image sensor includes a stereo vision system; and
matching the object identified in the image with an object detected by the at least one proximity sensor comprises:
calculating depth information of a first object using a stereo image captured by the stereo vision system;
obtaining a distance measurement corresponding to a second object detected by the at least one proximity sensor; and
matching the first object identified in the image with the second object detected by the at least one proximity sensor as the same object when a difference between the depth information and the distance measurement is less than a threshold value.

7. The method of claim 1, wherein automatically adjusting the lighting system of the vehicle based on the environmental information comprises:
obtaining a lighting adjustment configuration based on the environmental information; and
adjusting the lighting system according to the lighting adjustment configuration.

8. The method of claim 7, wherein:
the lighting adjustment configuration comprises increasing a light intensity on a region associated with the object; and
adjusting the lighting system according to the lighting adjustment configuration further comprises:
identifying a first lamp having a light beam passing through the region, and turning on the first lamp or increasing a light intensity of the first lamp; or
identifying a second lamp having a light beam not passing through the region, and adjusting an illuminate direction of the second lamp to illuminate the region.

9. The method of claim 7, wherein:
the lighting adjustment configuration comprises decreasing a light intensity on a region associated with the object; and
adjusting the lighting system according to the lighting adjustment configuration further comprises:
identifying a first lamp having a light beam passing through the region; and
performing at least one of:
turning off the first lamp, decreasing a light intensity of the first lamp, or adjusting an illuminate direction of the first lamp to avoid the region; or
identifying a second lamp having a light beam passing through the region and having a lower intensity than the first lamp, turning on the second lamp, and turning off the first lamp.

10. The method of claim 7, wherein automatically adjusting the lighting system of the vehicle based on the environmental information comprises:
obtaining a type of the object from the environmental information; and
adjusting the lighting system according to the lighting adjustment configuration corresponding to the type of the object.

11. The method of claim 10, wherein adjusting the lighting system according to the lighting adjustment configuration further comprises:
identifying a current lamp having a light beam passing through a region associated with the object, an illumination pattern of the current lamp on the region being at a first mode, the illumination pattern comprising at least one of an intensity or an illuminate direction of the current lamp; and
adjusting the illumination pattern of the current lamp on the region to a second mode based on the lighting adjustment configuration.

12. The method of claim 11, further comprising:
tracking the object and updating information associated with the region.

13. The method of claim 12, further comprising:
adjusting the illumination direction of the current lamp according to the updated information associated with the region;
wherein:
tracking the object and updating the information associated with the region comprises obtaining a relative moving speed of the object relative to the vehicle and an updated location of the object relative to the vehicle; and
adjusting the illuminate direction of the current lamp comprises rotating the current lamp or a reflector corresponding to the current lamp at an angular speed based on the relative moving speed and the updated location of the object.

14. The method of claim 12, further comprising:
identifying an updated lamp to be adjusted based on the updated information of the region; and
adjusting an illumination pattern of the updated lamp on the region;
wherein:
the updated information of the region includes an updated location of the region; and
identifying the updated lamp to be adjusted includes identifying a lamp having a light beam passing through the updated location of the region as the updated lamp.

15. The method of claim 14, wherein adjusting the lighting system according to the lighting adjustment configuration further comprises:
after identifying the updated lamp, changing the illumination pattern of the current lamp from the second mode to the first mode.

16. The method of claim 12, wherein:
tracking the object and updating the information associated with the region comprises obtaining a relative moving direction of the object relative to the vehicle; and
determining the updated lamp to be adjusted comprises determining a lamp located at an immediate neighboring position of the current lamp as the updated lamp based on the relative moving direction of the object.

17. The method of claim 10, wherein:
the type of the object is a vehicle type; and
adjusting the lighting system according to the lighting adjustment configuration corresponding to the type of the object comprises:
recognizing a window region of the object; and
lowering an intensity of light directed toward the window region.

18. The method of claim 10,
wherein:
the type of the object is a vehicle type; and
adjusting the lighting system according to the lighting adjustment configuration corresponding to the type of the object comprises:
recognizing a license plate region of the object; and
increasing an intensity of light directed toward the license plate region;
the method further comprising:
recognizing a plate number of the license plate region.

19. The method of claim 7, wherein:
the lighting system comprises two lamp groups located at two sides of the vehicle, each lamp group comprising a high beam lamp and a low beam lamp; and
automatically adjusting the lighting system comprises:
obtaining a relative movement between the vehicle and the object by tracking the object based on the environmental information, the relative movement including the vehicle and the object moving in approximately opposite directions; and
identifying the lighting adjustment configuration for the two lamp groups based on the relative movement, the lighting adjustment configuration including turning off the high beam lamp in one of the two lamp groups.

20. The method of claim 19, wherein:
each of the two lamp groups comprises multiple high beam lamps;
the lighting adjustment configuration further comprises turning on high beam lamps of one lamp group; and
automatically adjusting the lighting system of the vehicle comprises turning on one or more of the high beam lamps of the one lamp group that do not have a light beam passing through a region of the object.
